(19) United States
(12) Patent Application Publication
(10) Pub. No.: US 2025/0386774 A1
(43) Pub. Date: Dec. 25, 2025

(54) DEVICE AND APPARATUS FOR HORTICULTURAL LIGHTING AND VENTILATION

(71) Applicant: Schuyler David Milton, Vienna, VA (US)

(72) Inventor: Schuyler David Milton, Vienna, VA (US)

(21) Appl. No.: 19/002,766

(22) Filed: Dec. 27, 2024

Related U.S. Application Data
(63) Continuation-in-part of application No. 18/751,235, filed on Jun. 22, 2024, now Pat. No. 12,338,986.

(51) Int. Cl. A01G 9/24

(52) U.S. Cl. CPC A01G 9/249; A01G 9/246

(57) ABSTRACT

A horticultural lighting and ventilation apparatus and method are disclosed for use in controlled environment agriculture (CEA), including greenhouse and indoor horticulture applications. The apparatus comprises a hollow body equipped with a fan capable of moving air through the interior channel in multiple directions, thereby enabling selective intake and expulsion of air relative to a plant canopy. A plurality of light-emitting diodes (LEDs) attached to the hollow body provides high-efficiency illumination, while the forced airflow helps cool the LEDs and circulates air throughout the canopy to regulate temperature, humidity, and gas exchange. Embodiments include configurations for remote or network-based control of fan speed, direction, and LED intensity, allowing scalable arrays of the apparatus to deliver uniform or zoned environmental conditions in large horticultural facilities. The approach facilitates energy savings, improves microclimate stability, and enhances overall crop performance, particularly in densely planted or high-intensity growing environments.

### CROSS-REFERENCE TO RELATED APPLICATION(S)

This application is a continuation-in-part (CIP) of U.S. patent application Ser. No. 18/751,235, filed Jun. 22, 2024 and titled “DEVICE AND APPARATUS FOR HORTICULTURAL LIGHTING AND VENTILATION,” which is a continuation patent application of U.S. patent application Ser. No. 16/944,700, filed Jul. 31, 2020, which in turn claims the benefit of U.S. Provisional Patent Application No. 62/881,800, filed Aug. 1, 2019, the disclosures of all of which are hereby incorporated by reference in their entireties.

### FIELD OF THE INVENTION

The present invention relates to novel devices and apparatus for growing crops with horticultural lighting and ventilation. Specifically, the invention provides a combined lighting and ventilation system adaptable to a variety of controlled environment agriculture (CEA) scenarios, including but not limited to hydroponics, aeroponics, vertical farms, and greenhouse operations. The device can be oriented horizontally, vertically, or at an angle, and can integrate sensing, controllable airflow, and adjustable light spectra for optimal plant growth.

### BACKGROUND OF THE INVENTION

High density indoor horticulture and controlled environment agriculture (CEA) are methods of growing plants whereby the practitioner exerts direct control over one or more environmental component, including lighting, ventilation, temperature, CO₂ concentration, humidity, irrigation and fertilization. Often, CEA is practiced in tandem with hydroponics, a field of agriculture that encompasses growing crops using nutrient rich water. Hydroponics includes various subsets, specifically, aeroponics, deep water culture (DWC), nutrient film technique (NFT) and flood-drain systems.

Critical components of high-density horticulture and CEA addressed by the present invention are lighting and ventilation. Lighting is the means by which plants absorb photosynthetic energy. Ventilation is also critically important for plant growth to ensure delivery of fresh air, CO₂, and the control of humidity.

High density indoor horticulture and greenhouse horticulture both require precise control of the microenvironment to mitigate crop damage that can arise with high concentrations of light, heat and/or humidity. High density indoor horticulture and CEA have come to rely on LEDs for most applications, however in most instances each application inevitably wastes a considerable amount of energy in two ways. First, less than 100% of the photosynthetically active radiation actually falls on the crops, lighting the surrounding area instead, to no economic benefit. Second, high power LEDs placed at a distance greater than two feet from the crops produce a considerable amount of waste heat, which must be removed from the system requiring additional cost in utilities. High power LEDs (with individual chip output greater than or equal to 3 watts) cannot be used close to plants because the heat and high concentration of photons will damage crops. Lower power LEDs can be used closer to crops without causing damage to the crops, but when crops and LEDs are both used at high density both the LEDs and crops can both be damaged without adequate ventilation.

Further complicating the adoption of LEDs in greenhouse horticulture is the benefit that high-pressure sodium (HPS) lighting brings to greenhouses that benefit from the distributed heat produced by HPS lighting. While HPS lighting is less efficient at converting electricity to light, the waste heat resulting from this inefficiency can be beneficial to greenhouse cultivation in colder weather, providing needed heat to the interior of the greenhouse in colder weather.

### SUMMARY OF THE INVENTION

The present invention relates to novel devices and apparatus for growing crops with horticultural lighting and ventilation. The device serves two primary functions; (1) illuminating plants, and (2) circulating air. Embodiments of the device comprise a variety of forms which are specific to the particular application in which the device may be used. In all forms, the device comprises a hollow body to which a plurality of light emitting diodes (LEDs) are attached, and the device further comprises one or more holes along the surface of the hollow body, or at one end of the hollow body, through which circulated air may flow. A critical feature of the invention is that air can be pushed or pulled through the hollow body, drawing air from above, or at an angle substantially above, the hollow body and expelling it below, or at an angle substantially below, the hollow body. And similarly, the airflow may be directed in the reverse drawing air from below, or at an angle substantially below, the hollow body and expelling it above, or at an angle substantially above, the hollow body. The above example directions are relative to ground; however, the relative directions may change with the application. The device may further be used in an array of similar or identical devices. The device or array may further be networked such that each device, groups of devices within the array, or the entire array may be controlled remotely and independently. Similarly, the fans controlling the airflow within each device may be controlled in the same way, in groups or independently, including control over the fan direction and speed, enabling control over which direction air flows through the hollow body. The combination of lighting with ventilation, and directional control over the ventilation, enables previously unavailable efficiencies for Controlled Environment Agriculture. Moving air within enclosed spaces has substantial cost, as does installation of air moving devices. These costs add up significantly for greenhouse horticulture with installations that can span anywhere from less than one to over 100 acres. The combination of ventilation control within the LED fixtures improves the economics of the LEDs and the fixtures, in addition to reducing the installation costs by reducing or eliminating auxiliary ventilation units such as standalone fans. Additionally, ventilated lighting described herein provides uniform control of the microenvironment with large facilities. The economic benefit of optimizing microclimate is well known in the art, and is demonstrated by crop uniformity, yield, and reduced disease pressure.

### BRIEF DESCRIPTION OF THE DRAWINGS

In addition to the below drawings, the drawings of U.S. patent application Ser. No. 18/751,235, filed Jun. 22, 2024, are hereby incorporated by reference. The patent or application file may contain at least one drawing and/or photograph executed in color. If so, copies of this patent or patent application publication with color drawing(s) will be provided by the Office upon request and payment of the necessary fee.

FIG. 1 shows a wireframe model of one embodiment of the invention in which the hollow body 1 comprises a fan 2 at one end of the hollow body 1, and a hole 3 on an opposing face.

FIG. 2 shows a wireframe model of one embodiment of the hollow body 1 from the opposite angle depicted in FIG. 1. In addition to the location of the fan 2 and hole 3, the lighted surface 4 is also shown here on the same surface as the hole 3.

FIG. 3 shows a side, or profile, view of the same hollow body 1 depicted in FIG. 1 and FIG. 2.

FIG. 4 shows a side view of the hollow body 1, with color airflow lines to highlight the magnitude and direction of airflow in and around the hollow body 1. This example shows air entering the hollow body 1 via the fan 2, traveling through the hollow body 1 and over the inner surface of the lighted surface 4, and exiting the hollow body 1 at the hole 3.

FIG. 5 shows a side view of the hollow body 1, with color airflow lines to highlight the magnitude and direction of airflow in and around the hollow body 1. This example shows air being expelled from the hollow body 1 via the fan 2. The expelled air is drawn into the hollow body 1 via the fan 2, through the hole 3, traveling through the hollow body 1 and over the inner surface of the lighted surface 4, before exiting the hollow body 1 at the location of the fan 2.

### DETAILED DESCRIPTION OF THE INVENTION

In addition to the following description, the specification of U.S. patent application Ser. No. 18/751,235, filed Jun. 22, 2024, is hereby incorporated by reference. The combination of LEDs and a ventilation unit solves a critical problem in the horticulture industry, which is the need to use LED lighting efficiently at very high density. Bringing the LED lights closer to the crops increases the lighting efficiency of the system and therefore the economic benefit of the system. However, this approach may not be applicable to a greenhouse environment where high-power lighting is used to supplement natural light.

Thus, the forgoing description has improved upon the prior work in this field to apply the concept of ventilated lighting to bring the added benefit of ventilation contained within this lighting to greenhouse environments. Ventilation of high-density horticulture systems is a persistent problem in greenhouse environments since high density invariably means higher transpiration requirements per unit area. Inadequate ventilation, particularly in greenhouse environments, can result in damage to the LEDs and associated hardware due to overheating and high humidity, in addition to crop loss resulting from poorly ventilated regions within a greenhouse. The present invention solves the problem of higher density applications of LEDs in greenhouse environments, and allows for the economic use of more efficient LEDs in high density horticulture.

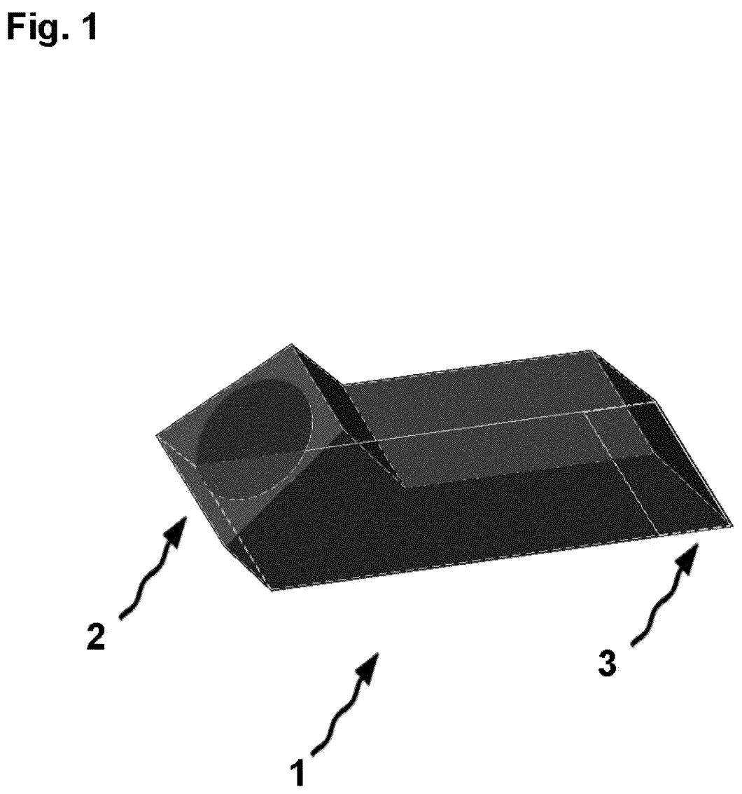

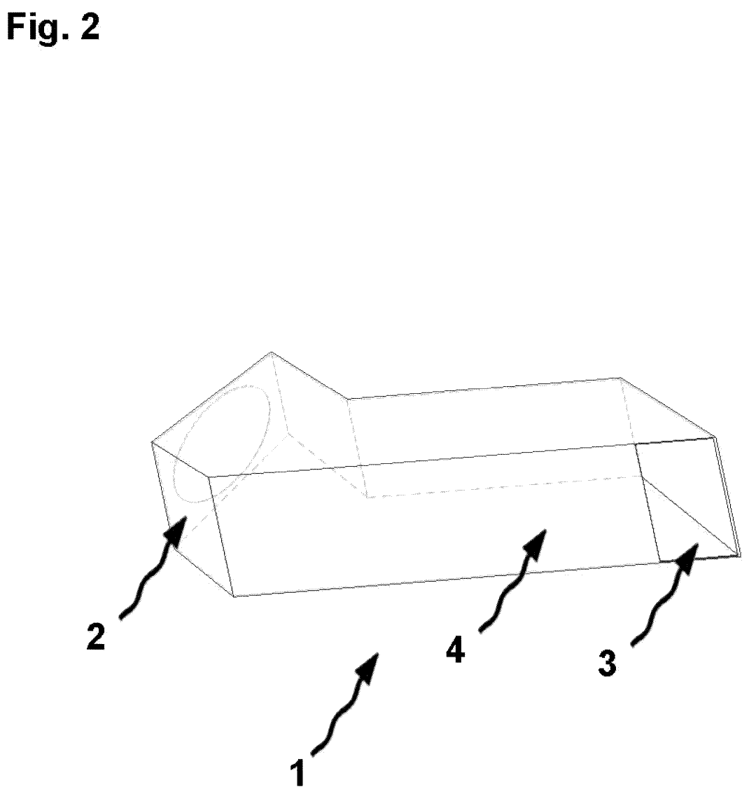

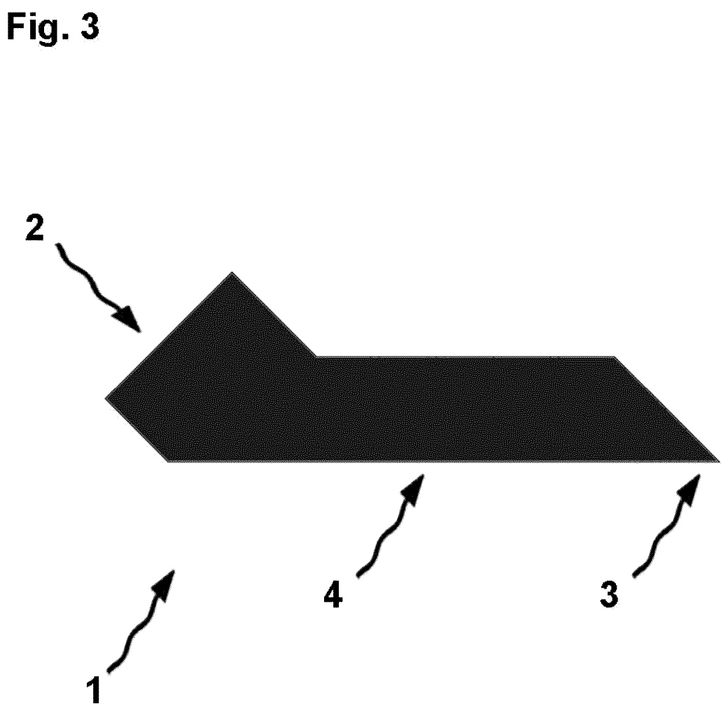

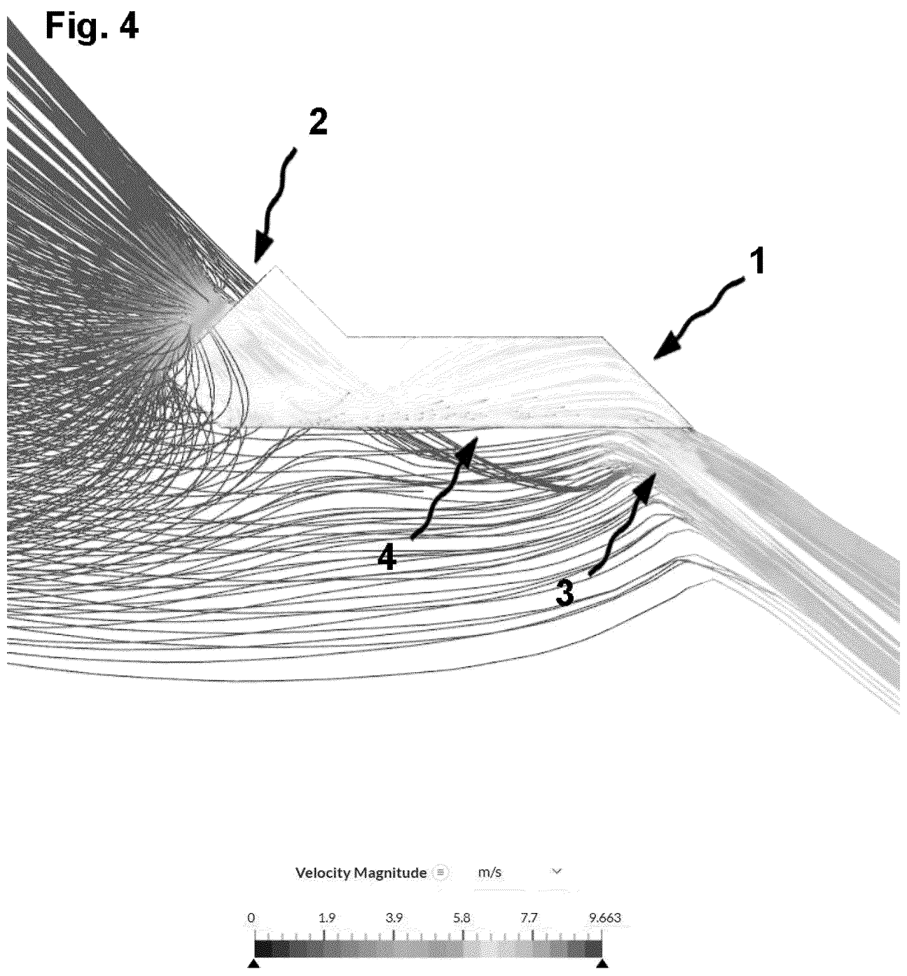

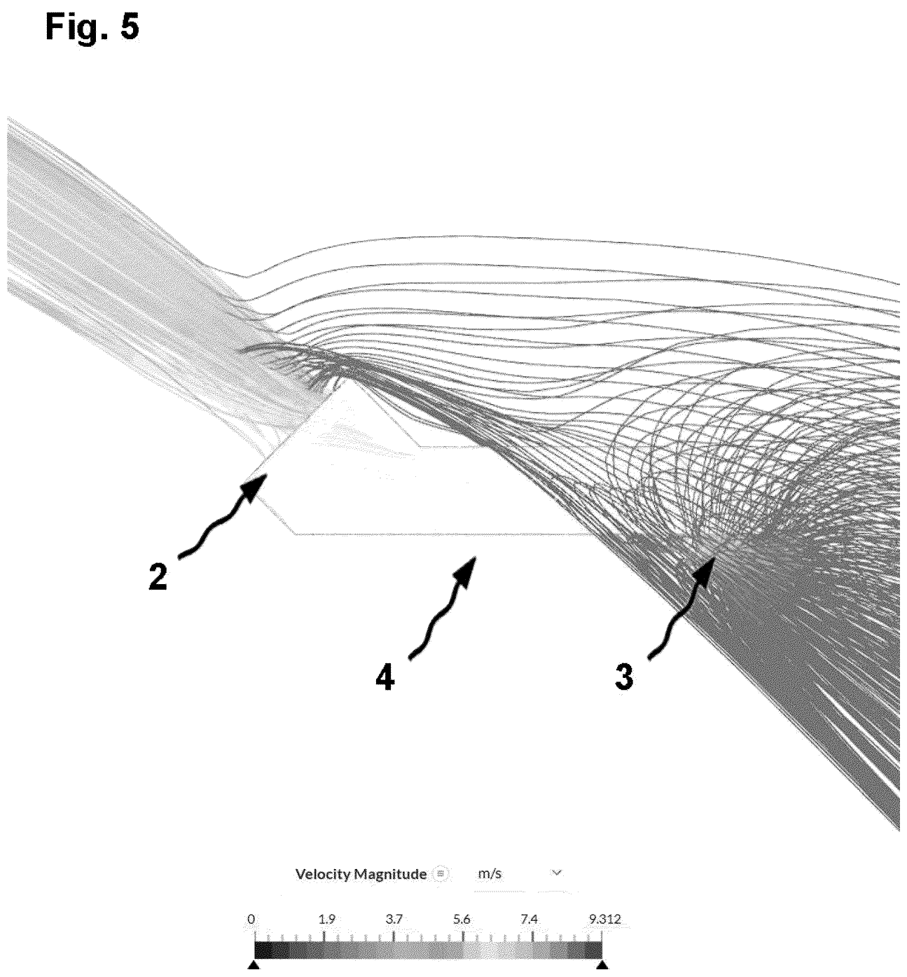

In a preferred embodiment of the invention, the device, FIG. 1-5, is comprised of a hollow body, with one end affixed to a fan and the opposing end open. An important feature of the invention is that when air is drawn into the hollow body from above, and/or from the side of the hollow body, the air passes through the hollow body to cool the LEDs, and exits the hollow body in the opposing direction from which it was drawn in, for example, through the same surface as the LEDs either through one or more holes interspersed between the LEDs or through a hole directed at such an angle that the air is expelled in a substantially similar direction as the light emitting from the LEDs.

In a preferred embodiment of the invention, the device, FIG. 1-5, is comprised of a hollow body, with one end affixed to a fan and the opposing end open. An important feature of the invention is that when air is drawn into the hollow body from below, and/or from the side of the hollow body, the air is drawn through the same surface as the LEDs either through one or more holes interspersed between the LEDs or through a hole directed at such an angle that the air is drawn in a substantially antiparallel direction as the light emitting from the LEDs. The air then passes through the hollow body and is expelled via the fan in a direction above, and/or to the side, of the hollow body, and substantially opposite the direction from which air was drawn into the hollow body.

The hollow body may have a cross-sectional shape of a circle, oval, triangle, square, rectangle, or other polygon as the application requires. The fan should may be independent or connected to a source of forced air such as a duct or air handling unit. The hollow body may have one or a plurality of holes on the same surface as the LEDs or an adjacent surface such that air forced into the hollow body is able to exit through the one or more holes. Light emitting diodes (herein, “LEDs”) attached to the outside of the hollow body are place at regular intervals and on the appropriate sides or angles of the hollow body to provide light as required by the specific horticultural application. The airflow through the one or more holes serves a dual purpose of (1) providing ventilation to the surrounding area, and (2) cooling the LEDs attached to the hollow body to prevent the LEDs from damage due to overheating and extend their usable lifespan, slowing light degradation. The hollow body itself may also serve as a heat sink for the LEDs attached to the hollow body.

According to an embodiment of the invention, the airflow supplied by the fan into or out of the hollow body, depending on direction the fan is operating, should be at least 0.1 cubic feet per minute (CFM), at least 1 CFM, at least 10 CFM, and/or at least 100 CFM as measured at the opening of one or more of the holes in the surface of the hollow body.

According to an embodiment of the invention, the individual LEDs each have a power output of less than 0.5 watts, 1 watt, 5 watts, 10 watts, and/or 100 watts. In aggregate, the plurality of LEDs mounted on the hollow body may have a combined power of at least 1 watt, 5 watts, 10 watts, 100 watts, 1000 watts, and/or more than 10,000 watts.

According to an embodiment of the invention the hollow body is made of metal. Metals appropriate for the application include, but are not limited to, galvanized steel, stainless steel, tin and aluminum. The hollow body may also be made of a molded materials such as polycarbonate, acrylonitrile butadiene styrene, or other thermoplastic as appropriate for the application.

According to an embodiment of the invention, LEDs may be absent on sides of the hollow body that are not facing plants as required by the application.

According to an embodiment of the invention, LEDs may be present on all sides of the hollow body.

According to an embodiment of the invention, LEDs are attached in a density sufficient to supply photosynthetically active radiation of at least 200 μmol/m²/s at a distance of 1 inch from a surface of the hollow body, at a distance of 6 inches from a surface of the hollow body, at a distance of 12 inches from a surface of the hollow body, and/or at a distance of 24 inches or more from a surface of the hollow body.

According to an embodiment of the invention, the LEDs attached to the hollow body are dimmable.

According to an embodiment of the invention, the LEDs attached to the hollow body are dimmed or modulated using pulse width modulation (PWM) or constant current reduction (CCR).

According to an embodiment of the invention, the modulation of the LEDs takes place using a network enabling remote control of the modulation.

According to an embodiment of the invention, the LEDs may be attached to the hollow body with adhesives such as glue or tape, or the LEDs may be attached using mechanical means such as brackets or plastic ties. The LEDs may also be attached using a combination of any of the above.

According to an embodiment of the invention, the device is assembled into an array of similar or identical devices to provide light and ventilation to an array of crops.

According to an embodiment of the invention, the device, or apparatus comprising multiple devices, is mobile, allowing the device to be repositioned relative to the crop-growing apparatus it is being used with. The mobility may come from being attached to wheels on the bottom. The mobility may also come from being attached to rails suspending the devices which can be adjusted horizontally or vertically as the application requires.

According to an embodiment of the invention, the fan is reversible, and controllable to modulate both direction and speed of the airflow.

According to an embodiment of the invention, the fan modulation takes place using a network enabling remote control of the modulation.

According to an embodiment of the invention, the fans in an array of the devices maybe controlled as a single group, smaller groups, or independently.

According to an embodiment of the invention, the fans may be used independently of the LEDs.

According to an embodiment of the invention, the fans in an array of devices are used to control the magnitude and direction of air in a controlled environment setting to achieve a desired environmental result, such as heat redistribution, humidity redistribution, and/or a particular airflow pattern.

According to an embodiment of the invention, the fans in an array of devices are modulated to direct heat upwards, downwards, or a combination thereof.

According to an embodiment of the invention, the fans in an array of devices are modulated to direct airflow to a particular region in a greenhouse, or in a particular pattern, in response to an external environmental factor, non-limiting examples of which include a change in external temperature of the greenhouse, a change in solar radiation, a change in external wind speed and/or direction, and/or a change in precipitation.

According to an embodiment of the invention, the fans in an array of devices are modulated to direct airflow to a particular region in a controlled environment, or in a particular pattern, in response to an internal environmental factor, non-limiting examples of which include a change in internal temperature in one or more internal regions of the greenhouse, a change in operation of other ventilation equipment within a greenhouse such as evaporative cooling mechanisms, a change in plant growth phase, and/or a change in lighting power applied to either the LEDs on the device or additional external artificial light sources.

According to an embodiment of the invention, the fans in an array of device may be modulated to direct airflow to a particular region in a controlled environment, or in a particular pattern, as a means to distribute or redistribute humidity, heat, cooling, aerosols, gasses or particulate matter.

According to an embodiment of the invention, the hollow body comprises or is coupled to a plurality of sensors configured to measure environmental parameters including, but not limited to, leaf temperature, photosynthetically active radiation (PAR), and root-zone moisture levels, wherein data from the sensors is used to automatically modulate fan direction and LED intensity in real time.

According to an embodiment of the invention, a machine-learning platform is integrated into a networked controller such that historical and real-time environmental data (temperature, humidity, CO₂ levels, etc.) are analyzed to predict future greenhouse conditions and automatically adjust the fan operation, LED spectrum, and LED intensity for optimal plant growth.

According to an embodiment of the invention, the fan and LED modules communicate via a standardized protocol (e.g., Modbus, BACnet, or a proprietary greenhouse automation interface) with a central greenhouse computer, allowing seamless coordination with other environmental control systems such as irrigation, heating, and venting.

According to an embodiment of the invention, the fan intake or hollow body inlet is equipped with a CO₂ injection port, enabling enriched CO₂ gas to be channeled through the hollow body and distributed near the plant canopy for improved photosynthetic efficiency.

According to an embodiment of the invention, one or more CO₂ sensors are situated in proximity to the hollow body, and the sensor data is used to trigger or adjust fan speed or airflow direction when CO₂ concentrations deviate from a desired range, ensuring uniform CO₂ distribution.

According to an embodiment of the invention, the hollow body includes internal heat-exchange fins or channels that absorb and redirect heat generated by the LEDs, wherein forced airflow through the hollow body carries warm air to cooler greenhouse zones to balance temperature gradients.

According to an embodiment of the invention, the device is configured to operate in parallel with high-pressure sodium (HPS) fixtures, wherein the reversible fan draws excess heat from the HPS fixtures and redistributes it around the canopy, partially offsetting the lower heat output of LEDs while capturing the lighting efficiency benefits of LEDs.

According to an embodiment of the invention, the hollow body is subdivided into modular sections, each with a removable panel for altering vent placement, LED density, or fan type, thereby allowing rapid reconfiguration for different crops or growth stages.

According to an embodiment of the invention, one or more detachable nozzles or duct attachments are installed on the hollow body vents to direct airflow in localized streams, enabling precision ventilation around specific leaf canopies, fruit clusters, or root zones.

According to an embodiment of the invention, the hollow body is mounted on a track or rail system allowing it to be slid vertically or horizontally to maintain an optimal distance from the crop canopy throughout various growth stages.

According to an embodiment of the invention, the LEDs mounted on the hollow body include multiple channels (e.g., red, blue, far-red, UV, and white), wherein each channel is individually controllable via a network interface to tailor the spectrum to the crop species or phenological stage.

According to an embodiment of the invention, the fan operates independently of the LEDs, allowing the LEDs to be powered off during a dark cycle while maintaining airflow to manage humidity or temperature during nighttime or non-lit hours.

According to an embodiment of the invention, the hollow body includes an antimicrobial or UV-based treatment section through which airflow passes, reducing pathogen load before distributing air around sensitive crops.

According to an embodiment of the invention, the hollow body may be equipped with an optional ionization or low-level ozonation unit to treat the air as it flows through the device, reducing airborne pathogens or mold spores before the air reenters the crop zone.

According to an embodiment of the invention, a monitoring subsystem logs energy usage of both the LEDs and fan over time, calculating real-time efficiency metrics (e.g., grams of produce per kWh), enabling growers to compare cost savings against conventional lighting and ventilation practices.

According to an embodiment of the invention, the device is produced in multiple sizes or wattage classes, with smaller units suited to laboratory-scale growth chambers and larger units adapted to multi-hectare greenhouses, maintaining uniform design principles for consistent performance and simplified maintenance.

According to an embodiment of the invention, the fan intake or hollow body inlet is configured to interface with misting or aerosol dispensing equipment, enabling directed delivery of nutrient solutions, beneficial microbes, or biocontrol insects throughout the canopy, leveraging the forced airflow.

According to an embodiment of the invention, multiple hollow bodies are arranged in designated microclimate zones, each with its own sensor suite and networked controller, allowing certain zones to be heated or cooled by adjusting fan direction and speed independently, without affecting adjacent zones.

According to an embodiment of the invention, the device uses color-coded LEDs or indicator lights on the external surface of the hollow body to show real-time operational status (e.g., green for normal operation, yellow for high temperature, red for system fault), simplifying routine walk-through inspections in large facilities.

According to an embodiment of the invention, each hollow body periodically sends operational data (power usage, temperature, airflow metrics, etc.) to a cloud-based dashboard. Growers can log in remotely to analyze trends, compare performance across different sections of the greenhouse, and optimize energy usage.

The forgoing embodiments are presented by way of example only; the scope of the present invention is to be limited only by the following claims.

What is claimed is:

1. A device for illuminating plants and circulating air, comprising:
a hollow body having at least one wall with a first opening and a second opening, the hollow body defining an interior channel through which air can flow;
a fan operatively coupled to the hollow body and configured to move air through the interior channel in at least two directions, wherein in a first direction air is drawn from an area substantially above and/or to one side of the hollow body and expelled below and/or to an opposite side of the hollow body, and in a second direction air is drawn from below or to the opposite side of the hollow body and expelled above or to said one side of the hollow body; and
a plurality of light-emitting diodes (LEDs) attached to an external surface of the hollow body, wherein the hollow body and the fan are arranged such that air moving through the interior channel provides cooling to the LEDs and ventilation to a surrounding agricultural environment.

2. The device of claim 1, further comprising:
a network interface operably connected to the fan and LEDs,
wherein the fan is controllable remotely via the network interface to adjust at least one parameter selected from the group consisting of fan speed, fan direction, and fan on/off state,
wherein the LEDs are controllable remotely via the network interface to adjust at least one parameter selected from the group consisting of brightness, power lever, color temperature, and on/off state.

3. The device of claim 1, wherein:
the hollow body is one of a plurality of similarly constructed hollow bodies each having a respective fan and LEDs,
the plurality of hollow bodies being arranged in an array to provide both lighting and ventilation across a large crop-growing area,
and wherein each of the plurality of fans is independently or collectively controllable to produce a desired airflow and lighting pattern in the controlled environment.

4. A method of controlling an environment in a greenhouse or indoor horticulture facility, comprising:
providing a plurality of horticultural lighting and ventilation devices, each comprising a hollow body with at least one wall, a fan configured for reversible airflow through the hollow body, and a plurality of LEDs mounted on an external surface of the hollow body;
positioning the plurality of devices in proximity to crops such that the LEDs illuminate the crops and air exiting from or entering through the hollow body traverses the crop canopy;
operating the fan in a first airflow direction to redistribute heat or humidity from a region substantially above the crops toward the crop canopy; and
in response to a change in an environmental parameter measured within the greenhouse or horticulture facility, reversing the airflow direction of at least one of the fans to draw air away from the crop canopy and expel it toward said region,
thereby providing dynamic control of temperature, humidity, and light levels around the crops.

5. The method of claim 4, further comprising:
monitoring an environmental parameter selected from temperature, humidity, CO₂ concentration, or light intensity using at least one sensor in communication with a central or distributed control system;
and automatically adjusting at least one operating parameter of the fans or the LEDs,
wherein the operating parameter is chosen from fan speed, fan direction, LED intensity, or LED photoperiod,
so as to maintain a target environmental condition within the greenhouse or horticulture facility while reducing energy costs.
